(19) United States
(12) Patent Application Publication
(10) Pub. No.: US 2005/0216791 A1
(43) Pub. Date: Sep. 29, 2005

(54) System and method for accessing to PCI bus data via a debug card

(76) Inventors: Win-Harn Liu, Taipei (TW); Horng-Yih Lin, Taipei (TW); Jeff Song, Taipei (TW); Bin Wu, Tianjin (CN); Yi-Song Li, Tianjin (CN); Wei-Ming Lee, Taipei (TW)

Correspondence Address: BIRCH STEWART KOLASCH & BIRCH, PO BOX 747, FALLS CHURCH, VA, 22040-0747, US

(21) Appl. No.: 10/798,394

(22) Filed: Mar. 12, 2004

(51) Int. Cl. G06F 11/00

(52) U.S. Cl. 714/25

(57) ABSTRACT

A system and method uses a debug card to access to PCI bus data. The debug card includes a PCI interface, a storage module, a data control chip and a host interface. First, the PCI interface of the debug card is used to access to the PCI bus data. The accessed data are stored in a buffer of the debug card. The data control chip of the debug card then is used to control the access to the data stored in the buffer of the debug card. The accessed data are stored in a buffer of the data control chip. Lastly, the host interface of the debug card is used to output the data stored in the buffer of the data control chip.

### BACKGROUND OF THE INVENTION

1. Field of Invention

The present invention relates to a system and method for accessing to PCI bus data. More particularly, the invention provides a system and a method for accessing to the PCI bus data via a debug card.

2. Related Art

PCI (Peripheral Component Interconnection) buses have been developed in 1993 by Intel to accommodate the development of the microprocessor functionality and the increase of the number of I/O modules. The PCI bus therefore has progressively replaced the traditional ISA (Industry Standard Architecture), providing a higher-speed standard for data transmission between the components of the computer host.

Presently, a personal computer host includes three main standard architectures: a structure based upon the ISA bus specification, a structure based upon the Intel Hub specification, and a structure based upon the LPC (Low Pin Count) bus specification. However, because the design of the LPC bus does not include control signals, it is therefore usually incompatible with the PCI bus standard. To solve this problem, the company Intel and other CPU manufacturers have proposed a solution, by which debug functionality pins are increased in the CPU so that the commands of the CPU can be followed.

A disadvantage of this solution is that it requires a CPU emulator, which increases the equipment cost.

Therefore, there is a need for a more economical method to access to the PCI bus data.

### SUMMARY OF THE INVENTION

It is therefore an objective of the invention to provide a system and a method for accessing to PCI bus data via a debug card, thereby the PCI bus data can be transferred to the desired processing device for analyzing or processing the data.

In one embodiment, a method for accessing to PCI bus data via a debug card includes the following steps. First, a PCI interface of the debug card is used to access to the PCI bus data. The accessed data are stored in a buffer of the debug card. A data control chip of the debug card then is used to control the access to the data stored in the buffer of the debug card. The accessed data are stored in a buffer of the data control chip. Lastly, a host interface of the debug card is used to output the data stored in the buffer of the data control chip.

In one embodiment, a debug card includes a PCI interface, a storage module, a data control chip, and a host interface. The PCI interface provides all kinds of connecting interface. The storage module stores the PCI bus data. The host interface operates as connecting interface with the computer host. The data control chip operates to control the access and transmission of PCI bus data. The data control chip includes an access control module, a transmission control module, a data storage module and a register. The access control module controls data accessing according to control signals. The transmission control module controls the data transmission according to control signals. The data storage module stores the PCI bus data obtained from the debug card. The register stores access control codes.

Compared to the conventional method, the invention does not require the high cost of a CPU emulator to follow the CPU debug pins, and instead economically uses the debug card to access to the PCI bus data.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is a general flowchart of a method for accessing to PCI bus data via a debug card according to an embodiment of the invention;

FIG. 2 is a flowchart of a process for accessing to data in the buffer of the debug card via the data control chip of the debug card according to an embodiment of the invention;

FIG. 3 is a flowchart of the control chip initialization procedure according to an embodiment of the invention;

FIG. 4 is a flowchart of the settings of the control chip being in an idle status according to an embodiment of the invention;

FIG. 5 is a flowchart of a process of extracting data from the data control chip by means of a host interface of the debug card according to an embodiment of the invention;

FIG. 6 is a block diagram of the system architecture implemented to access to PCI bus data via a debug card according to an embodiment of the invention; and

FIG. 7 is a block diagram of he system architecture implemented to access to PCI bus data via a debug card according to another embodiment of the invention.

### DETAILED DESCRIPTION OF THE INVENTION

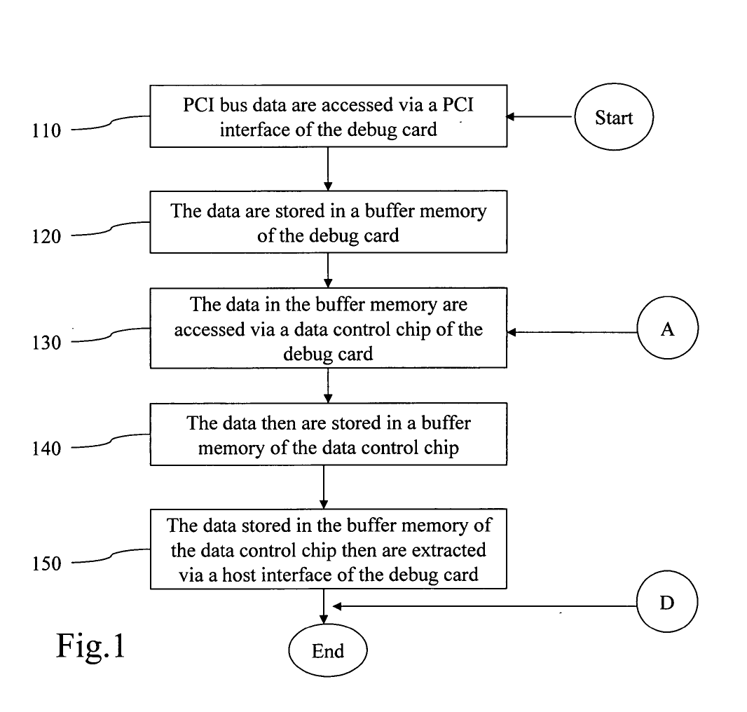

FIG. 1 is a general flowchart of a process for accessing to PCI bus data via a debug card according to an embodiment of the invention.

First, PCI bus data are accessed via a PCI interface of the debug card (step 110). The accessed data are stored in a buffer memory of the debug card (step 120). The data in the buffer memory are accessed via a data control chip of the debug card (step 130). The data then are stored in a buffer memory of the data control chip (step 140). The data stored in the buffer memory of the data control chip then are extracted via a host interface of the debug card (step 150).

The access to the PCI bus data is performed via an inner software program embedded in the debug card. This software program can be stored in a register of the debug card. Alternatively, the software program can be stored in an external storage device, such as a computer host connected to the debug card, from which it is downloaded into the debug card for execution. In an embodiment of the invention, the software program is stored in a USB8051 control chip.

While the debug card is accessing to the PCI bus data, a signal filter chip on the motherboard is used to analyze pin signals of the PCI bus. First, a request under the form of a control signal REQ# is transmitted to the bus arbitrator. The bus arbitrator responds to the request by a control signal GNT#. The right to access to the PCI bus is obtained after GNT# is received. Subsequently, in the addressing period, the address initiator determines the target and the switching status. In this embodiment, the “target” is a FIFO (“first-input-first-output”) buffer of the debug card. The target determines whether it is addressed and the transaction status. In the addressing period, the initiator provides the target only with an initial address. After the addressing period has been completed, the address/data bus becomes a data bus for transmitting data in each subsequent data period.

A data period means a time period in which information data are transmitted between the initiator and the target. In one data period, the transmitted data are according to the command and data packets set by the initiator. The duration of each data period is at least one PCI clock cycle, at the end of which the initiator and the target have to indicate that they are ready to complete one data period; otherwise, a standby status of one PCI clock cycle can be used to prolong the data period. For this purpose, ready signal lines IRDY# and TRDY# are respectively defined for the initiator and the target. The initiator does not issue information about the number of data packet transmitted to the target, but will instead indicate if the data packet being transmitted is the last one of each data period. In the beginning of the addressing period, FRAME# is driven to a low voltage level, and is subsequently sustained until the initiator (IRDY#) completes the last data period. The occurrence of a low voltage level of IRDY# with a high voltage level of FRAME# in one data period indicates to the target that it is the last data period. The data periods end only after the target sets TRDY# to a low voltage level. The transmitted data are thereby stored in the FIFO buffer of the debug card.

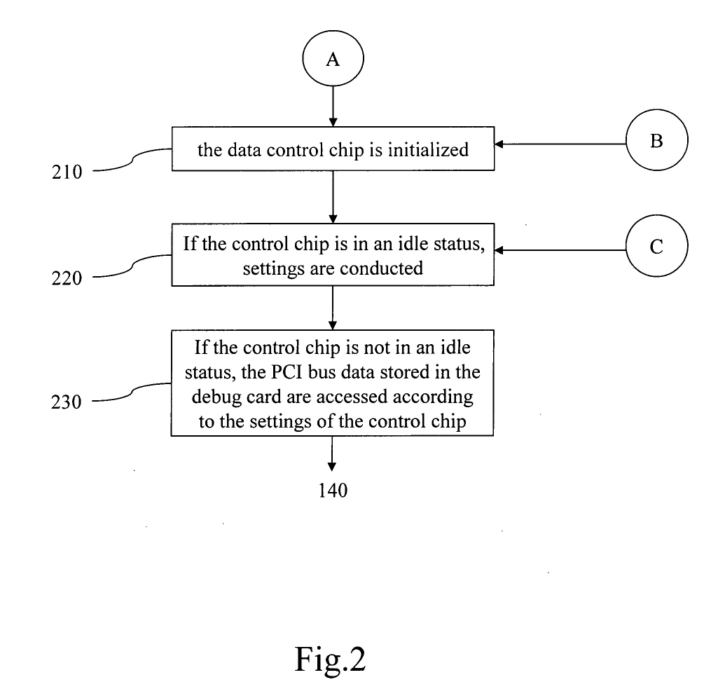

Reference now is made to FIG. 2 to describe the sequence flow of a process for accessing to data in the buffer via the data control chip of the debug card according to an embodiment of the invention. First, the data control chip is initialized (step 210). If the control chip is in an idle status, settings are conducted (step 220). If the control chip is not in an idle status, the PCI bus data stored in the debug card are accessed according to the settings of the control chip (step 230), then step 240 is executed.

If the three following conditions are satisfied, i.e. the data are not completely accessed, the data control chip has not accessed to data from the debug card, and the buffer memory of the control chip is not full, the control chip can enter in an idle status so that data access settings can be performed.

The PCI bus data are accessed according to the chip settings which are control codes stored in a register inside the control chip. According to the data transmission mode and the data access width respectively set during the idle status, the control chip subsequently accesses to the data that then are stored in the chip buffer.

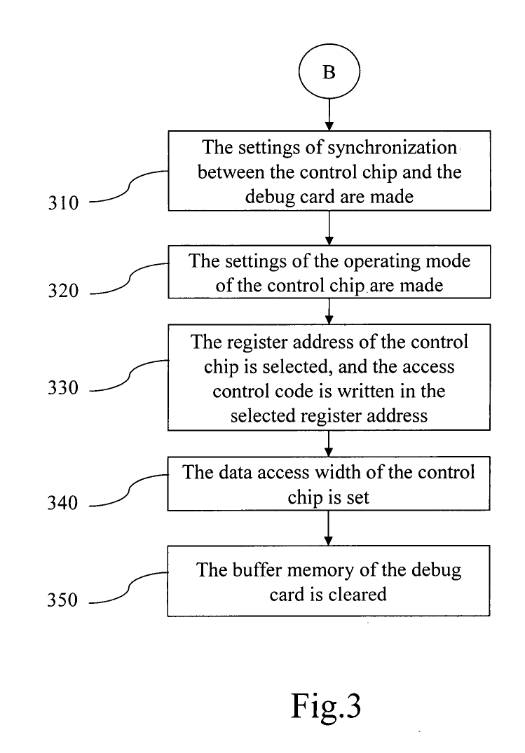

FIG. 3 is a flowchart of the control chip initialization procedure according to an embodiment of the invention. The settings of synchronization between the control chip and the debug card are made (step 310). The settings of the operating mode of the control chip are made (step 320). The register address of the control chip is selected, and the access control code is written in the selected register address (step 330). The data access width of the control chip is set (step 340). The buffer memory of the debug card is cleared (step 350).

An initialization of the control chip is necessary before it is used to access data. The synchronization settings include setting the chip clock frequency to 48 Hz, setting the clock frequency output towards the debug card, and stopping other running programs. The operating mode settings include setting RDY signal to an internal mode, and setting CTL signal to a CMOS mode. The RDY signal is sent from the debug card to the data control chip, and indicates that the current data is ready, and RDY1 indicates that the buffer is full and no new data are accessed.

In the embodiment of the invention, “WaveForm3” is selected as the register address in which is written the access control value. Further, the data access width is set to 16 bits.

After the initialization has been completed, the control chip enters into an idle status because it has not previously conducted data accessing. In the idle status, register values are tested. If the test conditions are satisfied, the values of some registers are set.

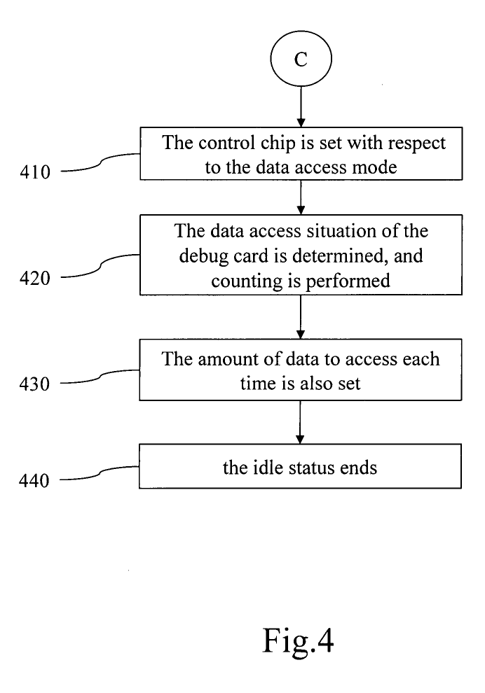

FIG. 4 is a flowchart of the settings of the control chip being in an idle status according to an embodiment of the invention. The control chip is set with respect to the data access mode (step 410). The data access situation of the debug card is determined, and counting is performed (step 420). The amount of data to access each time is also set (step 430). Once the above settings are completed, the idle status ends (step 440).

In an embodiment, the data width generated within the debug card is 40 bits, while the data signal line width of the control chip is 16 bits. Therefore, three access times are implemented to process one 40 bit-data packet of the debug card. The control chip is set so as to have the signal line CTL0 access to the bits 0-15, the signal line CTL1 access to the bits 16-31, and the signal line CTL2 access to the bits 32-39 of the data packet stored in the debug card. Lastly, when the signals are FD0-FD15, they are stored in the buffer of the control chip.

The determination of the data access situation of the debug card enables to evaluate whether the buffer of the debug card is full, which establishes a basis for calculating the accumulation of accessed data. Counting in step 420 means that data accessed each time are accumulated into the current data amount. The control chip has four buffers, being respectively EP2, EP4, EP6, and EP8. The buffer EP8 is used to store data accessed from the debug card.

Setting the data access amount determines the number of data packets to access it the next non-idle status.

Once the idle status ends, the control chip turns to a non-idle status to perform data accessing.

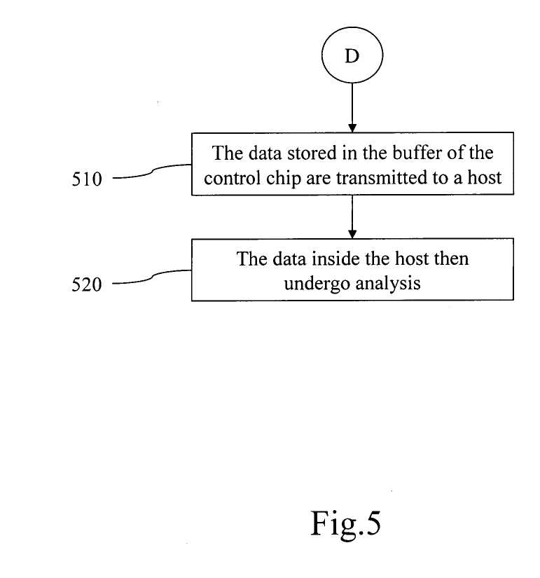

FIG. 5 is a flowchart of a process of extracting data from the data control chip by means of a host interface of the debug card according to an embodiment of the invention. The data stored in the buffer of the control chip are transmitted to a host (step 510). The data inside the host then undergo analysis (step 520).

To analyze the PCI bus data, the data stored in the buffer of the control chip are transmitted to a computer host. This data transmission is conducted by means of the access control codes stored in the register. According to the demand, the adequate software program is applied to analyze or process the data.

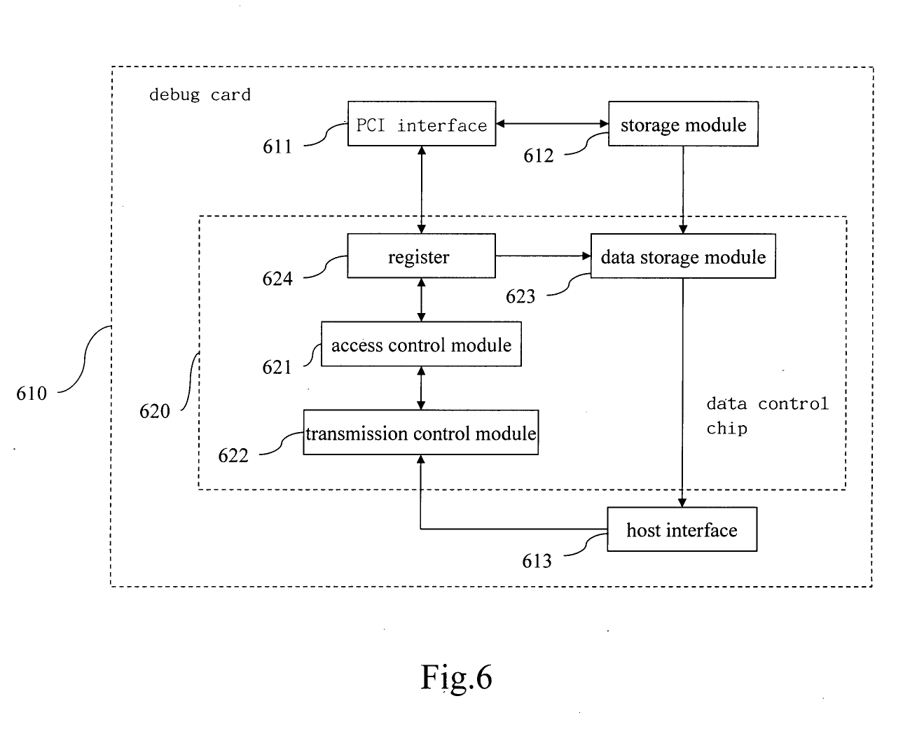

Reference now is made to FIG. 6 to describe the system architecture implemented to access to PCI bus data via a debug card according to an embodiment of the invention. The system architecture is based upon a debug card 610 including a PCI interface 611, a storage module 612, a data control chip 620 and a host interface 613. The data control chip 620 further includes an access control module 621, a transmission control module 622, a data storage module 623 and a register 624.

The PCI interface 611 is configured to provide all kinds of connecting interface. The storage module 612 stores PCI bus data. The host interface 613 operates as a connecting interface between the debug card and the host. The data control chip 620 is operable to control the access and transmission of the PCI bus data. The access control module 621 operates to control the data access according to control signals. The data storage module 623 stores the PCI bus data obtained from the debug card. The register 624 stores the access control command. The host interface can be a USB interface.

In an embodiment of the invention, the data control chip is a chip of the model “EZ-USBFX2” (called “FX2 chip”), the storage module is a register of the debug card, the data storage module is a buffer of the data control chip, and the debug card and the FX2 chip are coupled via a number of 21 connection pins.

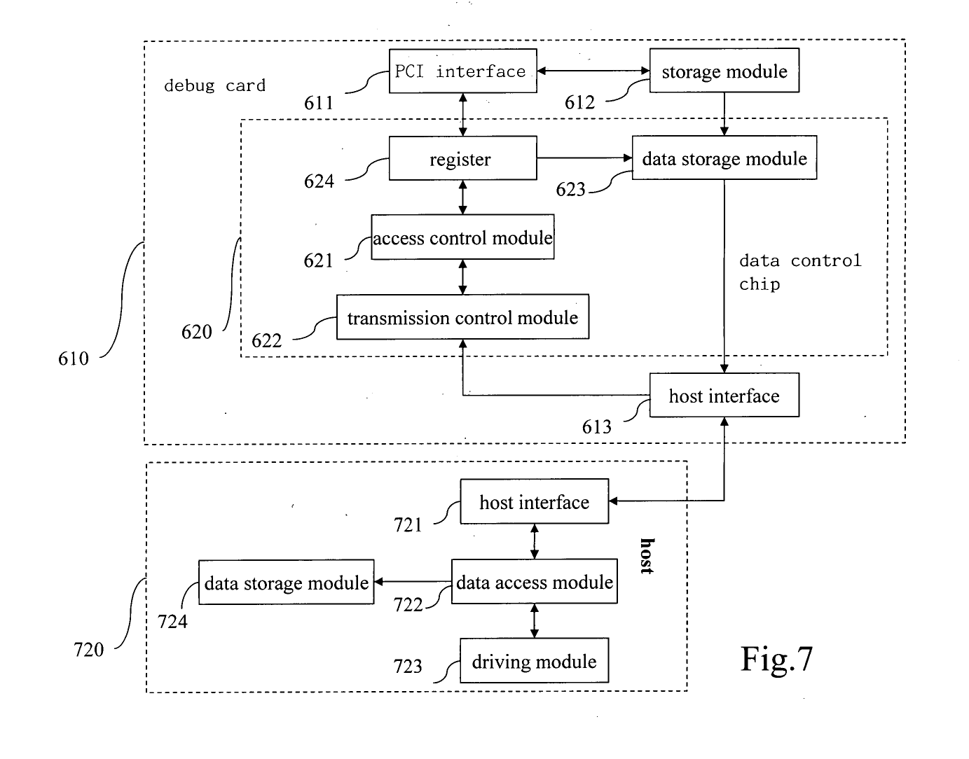

FIG. 7 is a block diagram of a system architecture implemented according to another embodiment of the invention. This variant system architecture includes a debug card 610 and a host 720. The debug card 610 includes a PCI interface 611, a storage module 612a data control chip 620 and a host interface 613. The host 720 includes a host interface 721, a data access module 722, a driving module 723 and a data storage module 724. The data control chip 620 includes an access control module 621, a transmission control module 622, a data storage module 623 and a register 624.

The host 720 receives data stored in the data control chip, and proceeds to analyze these data. The host interface 721 operates as connecting interface with the debug card. The data access module 722 controls the access to the data stored in the data control chip of the debug card. The driving module 723 stores the firmware program operable to control data accessing. The data storage module 724 stores the extracted PCI bus data.

A variant embodiment of the invention is described hereafter. The host stores an access control software program that is downloaded via a USB interface to a chip USB8051 within the debug card. Under request by the chip USB8051 to the bus arbitrator to obtain PCI bus data, the bus arbitrator answers to the request and transmits the data to the buffer of the debug card.

Subsequently, the data control chip of the debug card is initialized, by setting the synchronization of the control chip and the debug card, setting the operating mode, selecting the register address and writing the access control code, setting the data access width and clearing the buffer of the control chip.

Thereafter, the control chip enters into an idle status, sets the data access mode, determines the access situation inside the debug card and starts counting. Also, the amount of data at each access time is set. Lastly, the control chip ends the idle status and enters into the non-idle status for proceeding to the data access operation.

In the non-idle status, data stored in the debug card are accessed according to the settings of the control chip during the initialization and the idle status. The accessed data are stored in the buffer of the control chip. Data accessing is performed until the buffer of the control chip is full. If the buffer is full, the control chip turns to an idle status to await the next data access procedure.

Lastly, the access control software program transmits the data stored in the control chip via the USB interface to the data storage module of the host.

Thereby is achieved the access procedure to one data packet. This procedure is repeated until the access of all the necessary PCI bus data is completed. Thus, the PCI bus data can undergo analysis in the host.

It will be apparent to the person skilled in the art that the invention as described above may be varied in many ways, and notwithstanding remaining within the spirit and scope of the invention as defined in the following claims.

1. A method of accessing PCI bus data via a debug card, comprising:
accessing to data of the PCI bus via a PCI interface of the debug card;
storing the data in a buffer of the debug card;
controlling the access to the data stored in the buffer of debug card by means of a data control chip of the debug card;
storing the data in a buffer of the data control chip; and
extracting the data stored in the buffer of the data control chip via a host interface of the debug card.

2. The method of claim 1, wherein extracting the data stored in the buffer of the data control chip via a host interface of the debug card further comprising:
transferring the data stored in the buffer of the data control chip to the host; and
analyzing the data stored in the host.

3. The method of claim 1, wherein controlling the access to the data stored in the buffer of debug card by means of a data control chip of the debug card further comprising:
initializing the data control chip;
if the data control chip is in an idle status, setting the data control chip; and
if the data control chip is not in an idle status, accessing to the PCI bus data stored in the debug card according to the settings of the data control chip.

4. The method of claim 3, wherein initializing the data control chip further comprising:
performing a synchronization setting of the data control chip and debug card;
setting an operating mode of the data control chip;
selecting a register address in the data control chip and writing an access control code therein;
setting a data access width of the data control chip; and
clearing the buffer of the debug card.

5. The method of claim 3, wherein if the data control chip is in an idle status setting the data control chip further comprising:
setting a data access mode of the data control chip;
determining a data access situation of the debug card and performing counting;
setting an amount of data to be accessed each time; and
ending the idle status.

6. The method of claim 5, wherein ending the idle status further comprising preparing to perform a next data access.

7. The method of claim 3, wherein if the data control chip is not in an idle status, accessing to the PCI bus data according to the settings of the data control chip means accessing to the PCI bus data according to a control code stored in a register of the data control chip.

8. A debug card device, comprising:
a PCI interface operable as a connecting interface with a PCI bus;
a storage module for storing PCI bus data; and
a data control chip operable to control the access and transmission of PCI bus data, the data control chip including:
an access control module for controlling data access according to a control signal;
a transmission control module for controlling data transmission according to a control signal;
a data storage module for storing PCI bus data obtained from the debug card;
a register for storing an access control command; and
a host interface operable as an interface with a host.

9. The debug card device of claim 8, further being connected to a host via a host interface, wherein the host comprising:
a host interface operable as a connecting interface with the debug card;
a data access module operable to control the access of the PCI bus data in the data control chip of the debug card;
a driving module providing an access control firmware program; and
a data storage module for storing extracted PCI bus data.

10. The debug card device of claim 8, wherein the storage module is a buffer of the debug card.

11. The debug card device of claim 8, wherein the data storage module is a buffer of the data control chip.

12. The debug card device of claim 8, wherein the host interface is a USB interface.

13. The debug card device of claim 9, wherein the host interface is a USB interface.
